(19) United States
(12) Patent Application Publication
(10) Pub. No.: US 2019/0020170 A1
(43) Pub. Date: Jan. 17, 2019

(54) SINGLE OPTICAL FIBER-BASED MULTI-RING LASER BEAM DEVICE, AND MANUFACTURING METHOD THEREFOR

(71) Applicant: Kyung Yong LEE, Busan (KR)

(72) Inventor: Kyung Yong LEE, Busan (KR)

(21) Appl. No.: 16/066,646

(22) PCT Filed: Feb. 22, 2017
(86) PCT No.: PCT/KR2017/001948

§ 371 Date: Jun. 27, 2018

(30) Foreign Application Priority Data
Feb. 29, 2016 (KR) 10-2016-0024667
Oct. 11, 2016 (KR) 10-2016-0131570

(51) Int. Cl. H01S 3/067

(52) U.S. Cl. CPC H01S 3/06791; H01S 3/06704; H01S 3/06725

(57) ABSTRACT

The present invention relates to a single optical fiber-based multi-ring laser beam device, and a manufacturing method therefor. The present invention enables a laser beam to be emitted in a single optical fiber through at least two stair-type processing methods by allowing the laser beam to be radially spread out in a lengthwise direction of the optical fiber in two or more ring forms. Therefore, if two ring-form light profiles are used instead of one ring-form light profile, an energy burden on a glass tube is reduced because of an energy dispersion effect such that a safe treatment effect can be provided without the risk of damage to the glass tube. In addition, according to one embodiment of the present invention, an unnecessary process is removed by forming two rings in one optical fiber instead of using two optical fibers, such that advantages of simple manufacturing and cost reduction are provided. Furthermore, according to another embodiment of the present invention, two or more ring-form light profiles are provided in one optical fiber such that an effect of enabling a glass tube size to be reduced is provided.

### TECHNICAL FIELD

The present invention relates to a single optical fiber-based multi-ring laser beam device and more specifically, to a single optical fiber-based multi-ring laser beam device, which enables a laser beam emitted straight in the case of optical fibers for a medical apparatus, to be emitted in a perpendicular direction at about 90° such that the laser beam is emitted in a circular direction of the central axis of an optical fiber at 360°.

### RELATED ART

Lasers of different wavelengths are used to treat veins such as varicose veins.

However, when used to treat veins, laser beams affect neurons. As a result, some people try to avoid laser treatment.

Against this backdrop, there is a need to disperse laser beams delivered through an optical fiber, which go straight, so as to prevent the laser beams from concentrating on one section of a vein and to spread out the laser beams through an energy dispersion effect.

### PRIOR ART DOCUMENT

### Patent Document

(Patent Document 1) Korean Laid-Open Patent Publication No. 10-2014-0143667 titled “Method of endovenouse laser surgery”

(Patent Document 2) Korean Patent No. 10-1004373 titled “Therapy apparatus for electrically stimulating acupuncture point mounted with laser emitting unit”

### DETAILED DESCRIPTION OF THE INVENTION

### Technical Problems

As a means to solve the above-described problems, the present invention provides a single optical fiber-based multi-ring laser beam device, and a manufacturing method therefor which enables a laser beam to be emitted in a single optical fiber from an optical fiber through a two-or-more-stair-type process in two or more ring forms such that the laser beam radially spreads out.

Further, the present invention provides a single optical fiber-based multi-ring laser beam device, and a manufacturing method therefor in which two ring-form light profiles are used rather than one ring-form light profile so as to reduce an energy burden on a glass tube through an energy dispersion effect.

Further, the present invention provides a single optical fiber-based multi-ring laser beam device, and a manufacturing method therefor in which two or more ring-form light profiles are provided in one optical fiber such that an unnecessary process is removed by forming two rings in one optical fiber instead of using two optical fibers and that the size of a glass tube size doesn't need to be scaled up.

However, the purposes of the present invention are not limited to the above-described ones. Other purposes that have not been mentioned will become apparent to those skilled in the art to which the present invention pertains from the descriptions that will be provided below.

### Technical Solutions

As a means to achieve the above-described purposes, a single optical fiber-based multi-ring laser beam device according to an embodiment of the present invention enables a laser beam to be emitted in a single optical fiber in a lengthwise direction of an optical fiber through a two-or-more-stair-type process in two or more ring forms such that the laser beam radially spreads out.

In this case, a single optical fiber-based multi-ring laser beam device according to another embodiment of the present invention includes: an optical-fiber outer cover 110 which is configured to cover an optical fiber; a multi-ring optical fiber 120 which is a part of the optical fiber covered by the optical-fiber outer cover 110 and is formed through a two-or-more-stair-type process at a section which is not covered by the optical-fiber outer cover 110; and a glass tube 130 which has an inner diameter D1 of the mouth 131 thereof larger than an inner diameter D2 of the main body 132 thereof such that the outer diameter of the optical-fiber outer cover 110 comes into the mouth 131 of the glass tube.

Further, in terms of a single optical fiber-based multi-ring laser beam device according to another embodiment of the present invention, the multi-ring optical fiber 120 may have a ring-form light profile, a first ring formation section 121A and a second ring process section 122 which are configured as a cylindrical lateral surface of a surface rotating along the central axis the optical fiber at 360° in a direction perpendicular to the direction P1 where a laser beam emitted through the optical fiber proceeds.

Further, in terms of a single optical fiber-based multi-ring laser beam device according to another embodiment of the present invention, the multi-ring optical fiber 120 includes a first ring process section 121 which has a shape that becomes narrower toward the central axis of the optical fiber having a cylinder shape on the multi-ring optical fiber 120 and which is configured to be a slant surface processed and formed so as to have a slant angle on a cross section of the cylinder; and a first ring formation section 121A which is formed at the middle section of the slant-angled section of the first ring process section 121 by means of a process of a flat surface parallel with the central axis of the optical fiber during the processing of the slant surface.

Further, in terms of a single optical fiber-based multi-ring laser beam device according to another embodiment of the present invention, the multi-ring optical fiber 120 may further include a second ring process section 122 which is formed from the end with the smallest diameter out of the first ring process section 121 that is the slant surface to a preset distance through cutting work for forming a flat surface and which is formed by means of a process of a flat surface parallel with the central axis of the optical fiber.

Further, in terms of a single optical fiber-based multi-ring laser beam device according to another embodiment of the present invention, the first ring formation section 121A and the second ring formation section 122 may be formed as big as the size of a cylindrical lateral surface that is a surface formed by means of a 360° rotation along the central axis the optical fiber.

Further, in terms of a single optical fiber-based multi-ring laser beam device according to another embodiment of the present invention, the multi-ring optical fiber 120 may further include a third ring process section 123 which is formed at the other end, not the end that touches the first ring process section 121 out of both ends of the second ring process section 122, and the end of the optical fiber is processed to have a coniform shape such that a laser beam is radially spread out through a slant surface with a coniform shape.

Further, in terms of a single optical fiber-based multi-ring laser beam device according to another embodiment of the present invention, the second ring process section 122 is configured to be larger than the first ring formation section 121A.

Further, a single optical fiber-based multi-ring laser beam device according to another embodiment of the present invention may further include an adhesion part 140 formed by means of adhesive materials at a section where the inner circumferential surface of the glass tube 130 touches the outer circumferential surface of the optical-fiber outer cover 110.

Further, in terms of a single optical fiber-based multi-ring laser beam device according to another embodiment of the present invention, the multi-ring optical fiber 120 is configured to have a diameter ranging from 100 μm to 1000 μm.

Further, in terms of a single optical fiber-based multi-ring laser beam device according to another embodiment of the present invention, a laser beam delivered for the first time to the optical fiber including the multi-ring optical fiber 120 has wavelengths ranging from 200 nm to 3000 nm, and an outer diameter of the glass tube 130 ranges from 0.5 mm to 50 mm while an inner diameter of the glass tube 130 ranges from 0.2 mm to 2 mm.

As a means to achieve the above-described purposes, a method of manufacturing a single optical fiber-based multi-ring laser beam device according to an embodiment of the present invention consecutively includes processing a multi-ring optical fiber 120, processing a glass tube 130, inserting an optical-fiber outer cover 110 into the glass tube 130, and forming and fixing an adhesion part 140 in the inserted section at the time of manufacturing any one of the above-described single optical fiber-based multi-ring laser beam devices.

### Advantageous Effects

A single optical fiber-based multi-ring laser beam device according to an embodiment of the present invention uses two ring-form light profiles instead of one ring-form light profile so as to reduce an energy burden on a glass tube through an energy dispersion effect such that a safe treatment effect can be provided without the risk of damage to the glass tube.

A single optical fiber-based multi-ring laser beam device according to another embodiment of the present invention forms two rings in one optical fiber instead of using two optical fibers thereby enabling an unnecessary process to be removed, simplifying a manufacturing process and reducing costs.

Furthermore, a single optical fiber-based multi-ring laser beam device according to another embodiment of the present invention provides two or more ring-form light profiles in one optical fiber such that the size of a glass tube is reduced.

### BRIEF DESCRIPTION OF THE INVENTION

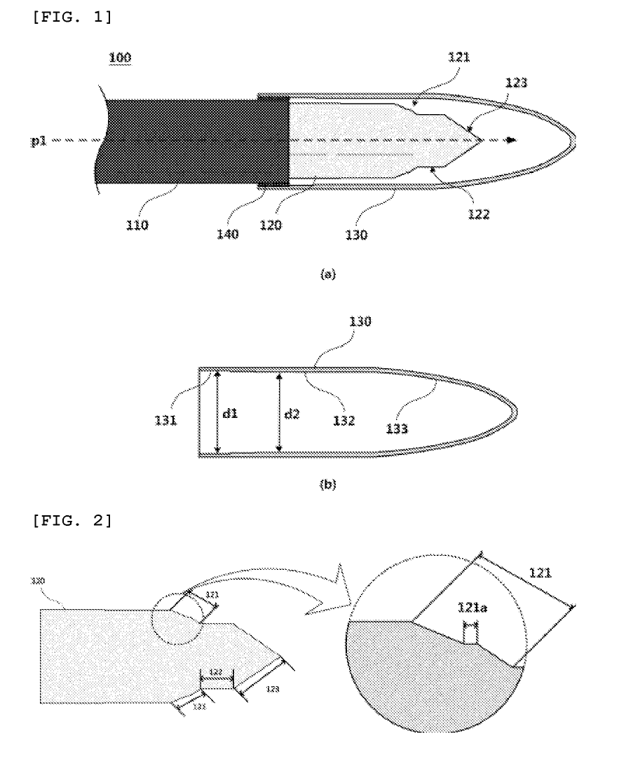

FIG. 1 is a sectional view illustrating a single optical fiber-based multi-ring laser beam device 100 according to an embodiment of the present invention.

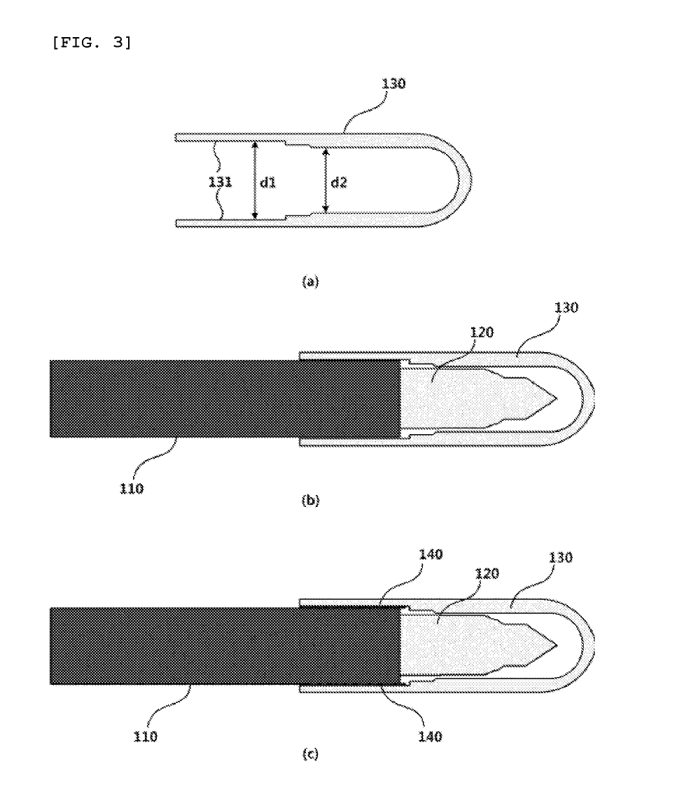

FIG. 2 is a sectional view illustrating a multi-ring optical fiber 120 of the single optical fiber-based multi-ring laser beam device 100 in FIG. 1

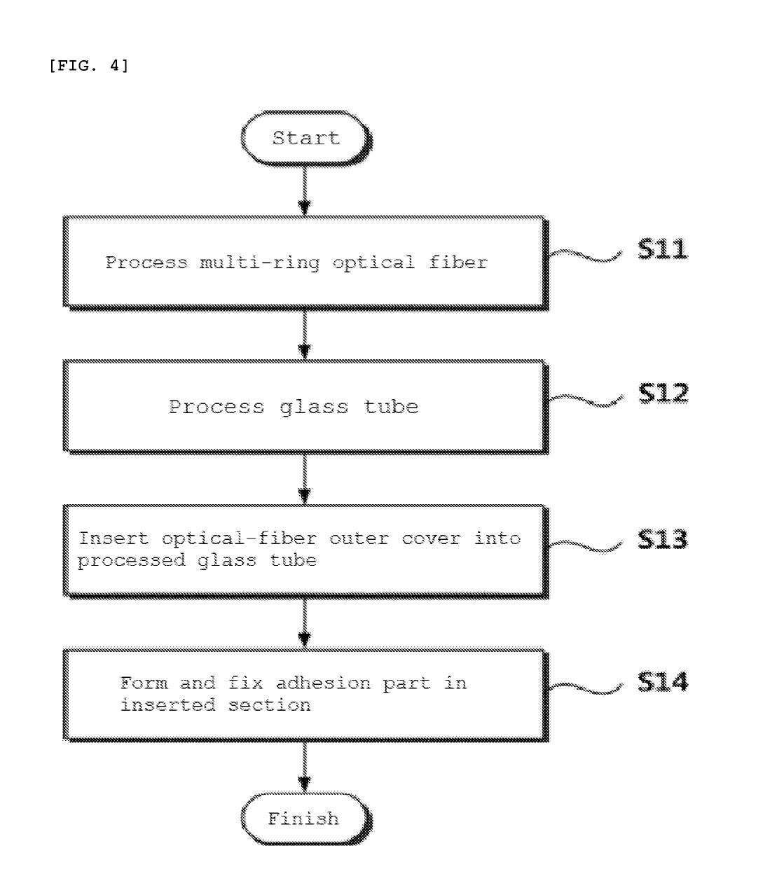

FIG. 3 is a view illustrating a process of manufacturing a single optical fiber-based multi-ring laser beam device 100 according to an embodiment of the present invention.

FIG. 4 is a flow chart illustrating a method of manufacturing a single optical fiber-based multi-ring laser beam device 100 according to an embodiment of the present invention.

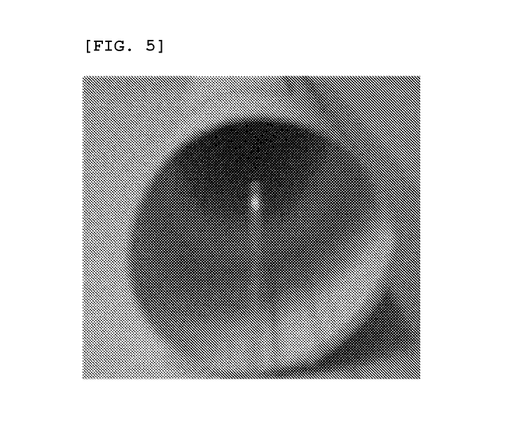

FIG. 5 is a reference view illustrating a prototype of the single optical fiber-based multi-ring laser beam device 100 manufactured according to the method of the embodiment of the present invention in FIG. 4.

### MODE FOR CARRYING OUT THE INVENTION

The present invention may be modified and embodied in various different forms, and specific embodiments of the present invention will be described in detail with reference to the attached drawings. However, it should be understood that the present invention is not limited to the embodiments set front herein and that all modifications, equivalents, alternatives within the scope of the spirit and technology of the present invention are included in the present invention.

It should be understood that although the terms “first”, “second”, etc. may be used herein to describe various elements, these elements are not limited by the terms. The terms are only used to distinguish one element from another.

For instance, a first element may be referred to as a second element, and similarly, a second element may be referred to as a first element without departing from the scope of the right to the present invention. The term “and/or” when used in this specification, means including a combination of a plurality of relevant stated items or any one of the plurality of relevant stated items. Unless otherwise defined, all terms (including technical and scientific terms) used herein have the same meaning as commonly understood by one of ordinary skilled in the art to which this inventive subject matter belongs. It should be further understood that terms such as those defined in commonly used dictionaries are interpreted as having a meaning that is consistent with their meaning in the context of the relevant art and are not interpreted in an idealized or overly formal sense unless expressly so defined herein.

Below, preferred embodiments of a single optical fiber-based multi-ring laser beam device according to the present invention will be described with reference to the attached drawings. During description of the embodiments, the thickness of lines or the size of elements illustrated in the drawings may be exaggerated for the sake of convenience and clarity in description. Further, the terms that will be described hereunder are those defined considering the functions described in the present invention and may differ depending on the intention or the practice of the user or operator. Therefore, such terms should be defined on the basis of what is described throughout the specification.

FIG. 1 is a sectional view illustrating a single optical fiber-based multi-ring laser beam device 100 according to an embodiment of the present invention, and FIG. 2 is a sectional view illustrating a multi-ring optical fiber 120 of the single optical fiber-based multi-ring laser beam device 100 in FIG. 1.

First, with reference to FIGS. 1 and 2, a single optical fiber-based multi-ring laser beam device 100 includes an optical-fiber outer cover 110, a multi-ring optical fiber 120, a glass tube 130, and the multi-ring optical fiber 120 is provided with a first ring process section 121, a second ring process section 122, and a third ring process section 123.

The optical-fiber outer cover 110 is configured to cover an optical fiber and coupled to the glass tube inside the glass tube 130.

The multi-ring optical fiber 120 is a section of the optical fiber covered by the optical-fiber outer cover 110 and is not covered by the optical-fiber outer cover 110. That is, the multi-ring optical fiber is a section out of an optical fiber, which is inserted into the glass tube 130 at the time of joining the optical-fiber outer cover 110 and the glass tube 130.

Herein, the optical fiber including the multi-ring optical fiber 120 consists of materials such as SiO₂ (silica) etc., and the multi-ring optical fiber is configured to be a single optical fiber with a diameter ranging from 100 μm to 1000 μm and is used to output a two-or-more-ring laser beam. Herein, the laser beam delivered to the optical fiber including the multi-ring optical fiber 120 preferably has wavelengths ranging from 200 nm to 3000 nm.

Meanwhile, a multi-ring optical fiber 120 according to an embodiment of the present invention may be provided with a first ring process section 121, a second ring process section 122, and a third ring process section 123.

Herein, the first ring process section 121 has a shape that becomes narrower toward the central axis of the optical fiber having a cylinder shape on the multi-ring optical fiber 120, and is formed through the processing of a slant surface so as to have a slant angle on a cross section of the cylinder. During the processing of a slant surface, a first ring formation section 121A that is configured to be a flat surface parallel with the central axis of the optical fiber is formed together at the middle section of the slant-angled section of the first ring process section 121 such that a ring-form light profile, a first ring formation section 121 A are configured as a cylindrical lateral surface rotating along the central axis of the optical fiber at 360° in a direction perpendicular to the direction P1 where a laser beam emitted through the optical fiber proceeds.

That is, angles of refraction may be differentiated by the slant surface of the first ring process section 121, and a first rig-form light profile may be formed by the first ring formation section 121A at the middle of the first ring process section.

A second ring process section 122 which is formed from the end with the smallest diameter out of a first ring process section 121 that is a slant section to a preset distance through cutting work for forming a flat surface. That is, like the first ring formation section 121A of the first ring process section 121, a second ring formation section 121A that is configured to be a flat surface parallel with the central axis of the optical fiber is formed together such that a ring-form light profile may be formed in a direction perpendicular to the direction P1 where a laser beam emitted through the optical fiber proceeds. Such a second ring formation section 122 may be formed as large as the size of the cylindrical lateral surface that is formed by means of a 360° rotation along the central axis of the optical fiber.

The third ring process section 123 is formed at the other end, not the end that touches the first ring process section 121 out of both ends of the second ring process section 122, and the end of the optical fiber is processed to have a coniform shape such that a laser beam is radially spread out through a slant surface with a coniform shape.

Meanwhile, the second ring process section 122, as illustrated in FIGS. 1 and 2, is configured to be larger than the first ring formation section 121A such that the ring-form light profile emitted by the laser beam becomes larger at the end of the front of the glass tube 130 than at the body thereof.

The inner diameter Dl of the mouth 131 of the glass tube 130 is configured to be larger than the inner diameter D2 of the main body 132 of the glass tube such that the outer diameter of the optical-fiber outer cover 110 comes into the mouth 131 of the glass tune.

Meanwhile, a section where the inner circumferential surface of the glass tube 130 touches the outer circumferential surface of the optical-fiber outer cover 110 is fixed by means of an adhesion part 140 using adhesive materials such as glue, an adhesive pad, etc. such that the central axis of the multi-right optical fiber 120 and the central axis of the glass tube 130 are arranged on the same line.

Herein, the glass tube 130 is used to protect the multi-ring optical fiber 120, and instead of glass, quartz glass manufactured through the melting of quartz (SiO₂) or transparent acrylic materials may be used for the glass tube.

Meanwhile, preferably, the outer diameter of the glass tube 130 ranges from 0.5 mm to 50 mm, while the inner diameter of the glass tube 130 ranges from 0.2 mm to 2 mm, and in terms of the inner diameter, one or more step bumps are further formed towards the central axis among the above-described inner diameter (D1) of the mouth 131 of the glass tube, the above-described inner diameter D2 of the main body 132 of the glass tube, and as illustrated in FIG. 1B, the mouth 131 of the glass tube and the main body 132 of the glass tube such that angles of refraction of the laser beam output by the multi-ring optical fiber 120 are differentiated.

A single optical fiber-based multi-ring laser beam device 100 with this configuration enables a laser beam, which is emitted straight in the case of optical fibers for a medical apparatus, to be emitted in a circular direction at 360° in a perpendicular direction at about 90° with respect to a straight direction by using a multi-ring optical fiber 120 with two ring-form light profiles.

In this case, the multi-ring optical fiber 120 may emit a laser beam in two or more ring forms not in one ring form so as to produce the effect of using two or more optical fibers with a single-strand optical fiber.

FIG. 3 is a view illustrating a process of manufacturing a single optical fiber-based multi-ring laser beam device 100 according to an embodiment of the present invention, and FIG. is a flow chart illustrating a method of manufacturing a single optical fiber-based multi-ring laser beam device 100 according to an embodiment of the present invention.

Below, a method of manufacturing a single optical fiber-based multi-ring laser beam device 100 will be described in detail with reference to FIGS. 3 and 4. First, with reference to FIG. 4, a method of manufacturing a multi-ring laser beam device 100 consecutively includes processing a multi-ring optical fiber 120 (S11), processing a glass tube 130 (S12), inserting an optical-fiber outer cover 110 into the glass tube 130 (S13), and forming and fixing an adhesion part 140 in the inserted section (S14).

The processing of a multi-ring optical fiber 120 (S11) includes removing a cover of a part where the multi-ring optical fiber 120 is formed out of an optical-fiber outer cover 110 and consecutively performing first cutting work, second cutting work, and third cutting work to consecutively form a first ring process section 121, a second ring process section 122, and a third ring process section 123 respectively for the part where the cover is removed out of the optical fiber. Meanwhile, in the third cutting work, when processed in a coniform shape, the end of the optical fiber is processed in a coniform shape with polygonal mirror surfaces to enable the end of the optical fiber to induce scattered reflection thereby maximizing the effect of scattered reflection.

After step 11, the processing of a glass tube 130 (S12) includes preparing for a glass tube 130 provided with a process groove 131 at the time of manufacturing a glass tube 130 or preparing for a glass tube 130 having identical inner and outer diameters of the mouth 131 and the main body 132 thereof, making the inner diameter Dl larger than the inner diameter D2 of the main body 132 of the glass tube from a joined surface that is the mouth 131 of the glass tube to a certain length through a device for processing the caliber of a glass tube, processing an optical-fiber outer cover 110 in order for the optical-fiber outer cover 110 to come into the mouth 131 of the glass tube, obtaining a glass tube 130 with a processed mouth 131 as illustrated in FIG. 3A (S12).

After step 12, the optical-fiber outer cover 110 where the multi-ring optical fiber 120 is formed is inserted into the end of the inner circumferential surface of the mouth 131 of the processed glass tube 130 so as to obtain an intermediate product of a single optical fiber-based multi-ring laser beam device 100 as illustrated in FIG. 3B (S13).

After step S13, an adhesion part 140 is formed at a section where the outer circumferential surface of the outside 120 of the optical fiber touches the inner circumferential surface of the glass tube 130 out of the section where the optical-fiber outer cover 110 is inserted into the glass tube 130 so as to fix the optical-fiber outer cover 110 and the glass tube 130 such that a final product of a single optical fiber-based multi-ring laser beam device 100 as illustrated in FIG. 3C (S14).

Meanwhile, FIG. 5 is a reference view illustrating a prototype of the single optical fiber-based multi-ring laser beam device 100 manufactured according to the method of the embodiment of the present invention in FIG. 4.

Preferred embodiments of the present invention have been disclosed in the specification and drawings. The terminology used herein is intended only to easily describe and contribute to a better understanding of the technology of the present invention but is not intended to limit the scope of the present invention. It is apparent to those skilled in the art to which the present invention pertains that the present invention may be modified in various forms within the technical spirit and scope of the present invention besides the embodiments disclosed herein.

### DESCRIPTION OF THE SYMBOLS

100: Single optical fiber-based multi-ring laser beam device
110: Optical-fiber outer cover
120: Multi-ring optical fiber
121: First ring process section
121A: First ring formation section
122: Second ring process section
123: Third ring process section
130: Glass tube
131: Mouth of glass tube
132: Main body of glass tube
133: Curve part of glass tube

1. A single optical fiber-based multi-ring laser beam device is characterized in that a laser beam is emitted in a single optical fiber in a lengthwise direction of an optical fiber through a two-or-more-stair-type process in two or more ring forms so as to be radially spread out.

2. The single optical fiber-based multi-ring laser beam device according to claim 1, comprising:
an optical-fiber outer cover (110) which is configured to cover an optical fiber;
an multi-ring optical fiber (120) which is a part of the optical fiber covered by the optical-fiber outer cover (110) and is formed through a two-or-more-stair-type process at a section that is not covered by the optical-fiber outer cover (110); and
a glass tube (130) which has an inner diameter (D1) of a mouth (131) thereof larger than an inner diameter (D2) of a main body (132) thereof such that an outer diameter of the optical-fiber outer cover (110) comes into the mouth (131) of the glass tube.

3. The single optical fiber-based multi-ring laser beam device according to claim 2, wherein the multi-ring optical fiber (120) has a ring-form light profile configured as a cylindrical lateral surface rotating along the central axis the optical fiber at 360° in a direction perpendicular to the direction (P1) where a laser beam emitted through the optical fiber proceeds.

4. The single optical fiber-based multi-ring laser beam device according to claim 2, the multi-ring optical fiber (120) comprising:
a first ring process section (121) which has a shape that becomes narrower toward the central axis of the optical fiber having a cylinder shape on the multi-ring optical fiber (120) and which is configured to be a slant surface processed and formed so as to have a slant angle on a cross section of the cylinder; and
a first ring formation section 121A which is formed at the middle section of the slant-angled section of the first ring process section 121 by means of a process of a flat surface parallel with the central axis of the optical fiber during the processing of the slant surface.

5. The single optical fiber-based multi-ring laser beam device according to claim 4, the multi-ring optical fiber (120) further comprises a second ring process section (122) which is formed from the end with the smallest diameter out of the first ring process section (121) that is a slant surface to a preset distance through cutting work for forming a flat surface and which is formed by means of a process of the flat surface parallel with the central axis of the optical fiber.

6. The single optical fiber-based multi-ring laser beam device according to claim 5, wherein the first ring formation section (121A) and the second ring formation section (122) are formed as big as the size of a cylindrical lateral surface that is a surface formed by means of a 360° rotation along the central axis the optical fiber.

7. The single optical fiber-based multi-ring laser beam device according to claim 5, wherein the multi-ring optical fiber (120) further comprises a third ring process section (123) which is formed at the other end, not the end that touches the first ring process section (121) out of both ends of the second ring process section (122), and the end of the optical fiber is processed to have a coniform shape such that a laser beam is radially spread out through a slant surface with a coniform shape.

8. The single optical fiber-based multi-ring laser beam device according to claim 5, wherein the second ring process section (122) is configured to be larger than the first ring formation section (121A).

9. The single optical fiber-based multi-ring laser beam device according to claim 2, further comprising:
an adhesion part (140) formed by means of adhesive materials at a section where the inner circumferential surface of the glass tube (130) touches the outer circumferential surface of the optical-fiber outer cover (110).

10. The single optical fiber-based multi-ring laser beam device according to claim 2, wherein the multi-ring optical fiber (120) is configured to have a diameter ranging from 100 μm to 1000 μm.

11. The single optical fiber-based multi-ring laser beam device according to claim 10, wherein a laser beam delivered for the first time to the optical fiber including the multi-ring optical fiber (120) has wavelengths ranging from 200 nm to 3000 nm.

12. The single optical fiber-based multi-ring laser beam device according to claim 11, wherein an outer diameter of the glass tube (130) ranges from 0.5 mm to 50 mm while an inner diameter of the glass tube 130 ranges from 0.2 mm to 2 mm.

13. A method of manufacturing a single optical fiber-based multi-ring laser beam device consecutively comprises processing a multi-ring optical fiber (120), processing a glass tube (130), inserting an optical-fiber outer cover (110) into the glass tube (130), and forming and fixing an adhesion part (140) in the inserted section at the time of manufacturing a single optical fiber-based multi-ring laser beam devices.
